(19) United States
(12) Patent Application Publication
(10) Pub. No.: US 2021/0097268 A1
(43) Pub. Date: Apr. 1, 2021

(54) IMAGE PROCESSING METHOD AND APPARATUS, AND COMPUTER STORAGE MEDIUM

(71) Applicant: BEIJING SENSETIME TECHNOLOGY DEVELOPMENT CO., LTD., Beijing (CN)

(72) Inventors: Wentao LIU, Beijing (CN); Chen QIAN, Beijing (CN)

(21) Appl. No.: 17/117,703

(22) Filed: Dec. 10, 2020

Related U.S. Application Data
(63) Continuation of application No. PCT/CN2019/092353, filed on Jun. 21, 2019.

(30) Foreign Application Priority Data
Jul. 25, 2018 (CN) 201810829498.0

(51) Int. Cl. G06K 9/00; G06K 9/62; G06T 3/40; G06T 9/20; G06T 5/50

(52) U.S. Cl. CPC G06K 9/00362; G06K 9/6261; G06T 5/50; G06T 9/20; G06T 3/40

(57) ABSTRACT

An image processing method includes: obtaining a first image, and performing grid partition on the first image to obtain a plurality of grid control planes; determining a target object in the first image; and performing deformation processing on at least part of a body region of the target object corresponding to at least one of the plurality of grid control planes to generate a second image.

### CROSS REFERENCE TO RELATED APPLICATIONS

This application is a continuation of International Application No. PCT/CN2019/092353, filed on Jun. 21, 2019, which claims priority to Chinese Patent Application No. 201810829498.0, filed on Jul. 25, 2018. The disclosures of International Application No. PCT/CN2019/092353 and Chinese Patent Application No. 201810829498.0 are hereby incorporated by reference in their entireties.

### BACKGROUND

With the rapid development of Internet technologies, various image processing tools have emerged, which may process a target object in an image. For example, “body shaping” is performed on a target character in the image, such as “leg shaping”, “arm shaping”, “waist shaping”, “hip shaping”, “shoulder shaping”, “head shaping”, “chest shaping” and other operations of becoming fat or thin or becoming large or small, so that the figure of the character is processed more perfectly.

### SUMMARY

The present disclosure relates to image processing techniques, and in particular, to an image processing method and apparatus and a computer storage medium.

To solve the existing technical problem, embodiments of the present disclosure provide an image processing method and apparatus and a computer storage medium.

To achieve the foregoing objective, the technical solutions in the embodiments of the present disclosure are implemented as follows.

The embodiments of the present disclosure provide an image processing method, including: obtaining a first image, and performing grid partition on the first image to obtain a plurality of grid control planes; determining a target object in the first image; and performing deformation processing on at least part of a body region of the target object corresponding to at least one of the plurality of grid control planes to generate a second image.

The embodiments of the present disclosure also provide an image processing apparatus, including a memory storing processor-executable instructions; and a processor arranged to execute the stored processor-executable instructions to perform operations of: obtaining a first image, and performing grid partition on the first image to obtain a plurality of grid control planes; determining a target object in the first image; and performing deformation processing on at least part of a body region of the target object corresponding to at least one of the plurality of grid control planes to generate a second image.

The embodiments of the present disclosure further provide a non-transitory computer-readable storage medium having stored thereon computer-readable instructions that, when executed by a processor, cause the processor to perform an image processing method, the method including: obtaining a first image, and performing grid partition on the first image to obtain a plurality of grid control planes; determining a target object in the first image; and performing deformation processing on at least part of a body region of the target object corresponding to at least one of the plurality of grid control planes to generate a second image.

### BRIEF DESCRIPTION OF THE DRAWINGS

FIG. 1 is a schematic flowchart of an image processing method according to embodiments of the present disclosure;

FIG. 2 is a schematic structural diagram of an image processing apparatus according to embodiments of the present disclosure; and

FIG. 3 is a schematic structural diagram of a hardware composition of an image processing apparatus according to embodiments of the present disclosure.

### DETAILED DESCRIPTION

The present disclosure is further described below in detail with reference to the accompanying drawings and specific embodiments.

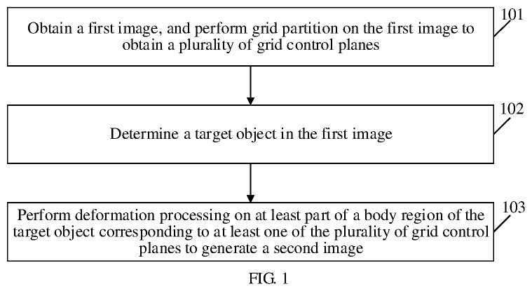

Embodiments of the present disclosure provide an image processing method. FIG. 1 is a schematic flowchart of an image processing method according to embodiments of the present disclosure. As shown in FIG. 1, the method includes the following operations.

At operation 101, a first image is obtained, and grid partition is performed on the first image to obtain a plurality of grid control planes.

At operation 102, a target object in the first image is determined.

At operation 103, deformation processing is performed on at least part of a body region of the target object corresponding to at least one of the plurality of grid control planes to generate a second image.

In the image processing method of the embodiments, image processing is performed on the first image, and grid partition is performed on the first image to obtain a plurality of grid control planes. As one implementation, the first image is evenly divided into N*M grid control planes, N and M are both positive integers, and N and M are the same or different. As another implementation, with the target object in the first image as the center, grid partition is performed on a rectangular region where the target object is located, and then grid partition is performed on the background region other than the rectangular region based on the grid partition granularity of the rectangular region.

In embodiments, the number of grid control planes is related to the proportion of the body region corresponding to the target object in the first image in the first image. For example, one grid control plane may correspond to a part of the body region of the target object. For example, one grid control plane corresponds to the leg of the target object, or one grid control plane corresponds to the chest and waist of the target object, so as to facilitate both the global deformation of the target object and the local deformation of the target object.

In the embodiments, the grid control plane is used as a basic deformation unit to process at least part of the body region of the target object, that is, the deformation processing is performed on the grid control plane, so as to implement deformation of at least part of the body region of the target object.

In the embodiments, a target object in the first image is identified, where the target object, as a to-be-processed object, may be a real person, which may be understood as a real character in the image. In other embodiments, the target object may also be a virtual character.

In the embodiments, the execution order of performing grid partition on the first image and identifying the target object in the first image does not limit the execution order in the embodiments, and the target object in the first image may be identified first, and then grid partition is performed on the first image to obtain a plurality of grid control planes.

In the embodiments, determining the target object in the first image includes: obtaining body detection information of the target object in the first image. The body detection information includes body key point information and/or body contour point information. The body key point information includes coordinate information of a body key point. The body contour point information includes coordinate information of a body contour point.

Specifically, the body region corresponding to the target object includes a head region, a shoulder region, a chest region, a waist region, an arm region, a hand region, a hip region, a leg region, and a foot region. The body detection information includes body key point information and/or body contour point information. The body key point information includes coordinate information of a body key point. The body contour point information includes coordinate information of a body contour point. The body contour point represents the body contour of the body region of the target object, that is, the body contour edge of the target object is formed by the coordinate information of the body contour point. The body contour point includes at least one of the following: an arm contour point, a hand contour point, a shoulder contour point, a leg contour point, a foot contour point, a waist contour point, a head contour point, a hip contour point, or a chest contour point. The body key point represents a key point of the bone of the target object, that is, the main bones of the target object are formed by the coordinate information of the body key points and connecting the body key points. The body key point includes at least one of the following: an arm key point, a hand key point, a shoulder key point, a leg key point, a foot key point, a waist key point, a head key point, a hip key point, or a chest key point.

In the embodiments, the target object in the first image is identified by means of an image identification algorithm to further determine the body detection information of the target object.

In the embodiments, performing deformation processing on at least part of the body region of the target object corresponding to at least one of the plurality of grid control planes includes: determining at least part of the body region to be subjected to deformation processing in the target object to obtain first body detection information of the at least part of the body region; and determining a first group of grid control planes corresponding to the first body detection information, and performing deformation processing on the first group of grid control planes.

Determining the first group of grid control planes corresponding to the first body detection information, and performing deformation processing on the first group of grid control planes includes: determining a corresponding first group of grid control planes based on first body key point information and/or first body contour point information included in the first body detection information, the first group of grid control planes including at least one grid control plane; and performing deformation processing on the at least one grid control plane to compress or stretch the at least part of the body region of the target object, and compress or stretch at least part of a background region other than the target object.

Here, at least part of the body region to be subjected to deformation processing, such as the waist region and leg region to be subjected to deformation processing, or the body region of the target object (i.e., an intact body region of the target object), of the target object is first determined. The first body detection information is further determined based on at least part of the body region to be subjected to deformation processing, specifically the coordinate information of the body key point and/or coordinate information of the body contour point of the at least part of the body region to be subjected to deformation processing. The first group of grid control planes corresponding to the at least part of the body region is determined based on the coordinate information of the body key point and/or coordinate information of the body contour point of the at least part of the body region. The first group of grid control planes includes at least one grid control plane, that is, at least one grid control plane corresponding to the at least part of the body region is determined. It can be understood that the at least part of the body region is located in a region corresponding to the at least one grid control plane.

In the embodiments, the grid control plane is rectangular in an initial state. The grid control plane further has a plurality of virtual control points (or has control lines). The curvatures of the control lines forming the grid control plane are changed by moving the control points (or control lines), so as to implement deformation processing of the grid control plane. It can be understood that the grid control plane subjected to deformation processing is a curved surface.

As one implementation, the grid control plane is a first-type grid control plane.

Determining the first group of grid control planes corresponding to the first body detection information, and performing deformation processing on the first group of grid control planes includes: determining at least one first-type grid control plane corresponding to the first body detection information, and performing deformation processing on the at least one first-type grid control plane based on a first deformation parameter to compress or stretch a part of the body region of the target object corresponding to the at least one first-type grid control plane, and compress or stretch at least part of a background region other than the target object.

Here, the first-type grid control plane includes a plurality of first-type grid control points. Performing deformation processing on the at least one first-type grid control plane based on the first deformation parameter includes: moving at least part of the plurality of first-type grid control points included in the first-type grid control plane based on the first deformation parameter, to perform deformation processing on the first-type grid control plane; where deformation of the first-type grid control plane is implemented by means of the movement of any one of the plurality of first-type grid control points.

Specifically, the first-type grid control plane may specifically be a Bézier surface formed by Bézier curves. The Bézier curve may have a plurality of control points, and it may be understood that the Bézier surface may be formed by a plurality of Bézier curves. The deformation processing of the Bézier curve is implemented by means of the movement of at least part of the plurality of control points corresponding to any Bézier curve. It may be understood that the deformation processing of the body region corresponding to the Bézier surface formed by the plurality of Bézier curves is implemented by means of the movement of control points of the plurality of Bézier curves. In the plurality of control points of the Bézier surface, the movement of any control point may deform the global Bézier surface.

The deformation processing of the intact body region of the target object is to deform at least one first-type grid control plane by referring to the first deformation parameter, that is, deformation processing is performed on the first-type grid control point to be adjusted in the first-type grid control plane according to the first-type deformation parameter, so that the intact body region of the target object is deformed according to the same deformation parameter. For example, the intact body region is compressed (“slim”) by 20%, where 20% is relative to the initial data. It may be understood that the width of the waist is compressed by 20% compared to the width of the waist before deformation, and the width of the legs is compressed by 20% compared to the width of the legs before deformation, etc.

The implementations are suitable for performing deformation processing on the intact body region of the target object by means of the Bézier surface, so as to achieve global smoothing of the deformation of the intact body region of the target object.

As another implementation, the grid control plane is a second-type grid control plane.

Determining the first group of grid control planes corresponding to the first body detection information, and performing deformation processing on the first group of grid control planes includes: determining at least one second-type grid control plane corresponding to the first body detection information, and performing deformation processing on the at least one second-type grid control plane based on a second deformation parameter to compress or stretch a part of the body region of the target object corresponding to the at least one second-type grid control plane, and compress or stretch at least part of a background region other than the target object.

Here, the second-type grid control plane includes a plurality of second-type grid control points. Performing deformation processing on the at least one second-type grid control plane based on the second deformation parameter includes: moving at least part of the plurality of second-type grid control points included in the second-type grid control plane based on the second deformation parameter, to perform deformation processing on the second-type grid control plane; where deformation of a region in the second-type grid control plane, corresponding to any one of the plurality of grid control points, is implemented by means of the movement of the second-type grid control point.

Specifically, the second-type grid control plane is specifically a catmull rom surface formed by catmull rom spline curves. The catmull rom spline curve may have a plurality of control points. It may be understood that the catmull rom surface may be formed by a plurality of catmull rom spline curves. The deformation processing of the catmull rom spline curve is implemented by means of the movement of at least part of the plurality of control points corresponding to any catmull rom spline curve. It may be understood that the deformation processing of part of the body region corresponding to the catmull rom surface formed by the plurality of catmull rom spline curves is implemented by means of the movement of control points of the plurality of catmull rom spline curves.

The difference between the first-type grid control plane and the second-type grid control plane in the embodiments is that taking the first-type grid control plane being a Bézier surface and the second-type grid control plane being a catmull rom surface as an example, during the deformation processing based on Bézier surface or catmull rom surface, the first-type grid control point is not on the Bézier curve forming the Bézier surface, and the curvature of the Bézier curve is changed by moving the first-type grid control point. It may be understood that the curvature of the corresponding Bézier curve in a larger range is changed by means of the movement of the first-type grid control point, thereby implementing the global deformation processing of the Bézier surface. The second-type grid control point is on the catmull rom curve forming the catmull rom surface, and the curvature and/or position of the second-type grid control point on the catmull rom curve is changed by moving the second-type grid control point. It may be understood that the curvature of a certain point on the corresponding catmull rom curve or the curve near the point is changed by means of the movement of the second-type grid control point, so as to implement the deformation processing of the local region in the catmull rom surface.

It may be understood that the deformation of part of the body region of the target object is implemented by means of the deformation processing of the catmull rom surface, which makes the local deformation more accurate and improves the effect of image processing.

Deformation processing is performed on at least one second-type grid control plane by referring to the second deformation parameter, so as to implement deformation processing of part of the body region of the target object. The second deformation parameters corresponding to different parts of the body region may be the same or different, so that different parts of the body region have different deformation effects. For example, the width of the waist is compressed by 20% compared to the width of the waist before deformation, and the width of the legs is compressed by 10% compared to the width of the leg before deformation.

In the embodiments of the present disclosure, regardless of the foregoing first-type grid control plane or the second-type grid control plane, the grid control point to be moved in the grid control plane is determined based on at least part of the body region to be subjected to deformation processing and the type of deformation processing (e.g., compression processing or stretching processing), so as to move the determined grid control points according to the corresponding deformation parameters.

In one embodiment, standard parameters are also configured during the image processing of the embodiments of the present disclosure. As implementations, the standard parameters indicate parameters satisfied by the body region of the processed target object, that is, when the image processing solution of the embodiments of the present disclosure is used to deform the body region, the body region satisfies the standard parameters, and then the deformation processing of the body region is terminated. As another implementation, the standard parameters indicate the adjustment ratio of the body region of the target object, that is, when the image processing solution of the embodiments of the present disclosure is used to process the body region, the adjustment change amount of the body region satisfies the adjustment ratio. On this basis, the embodiments of the present disclosure determine the deformation parameters (including the first deformation parameter or the second deformation parameter) based on the standard parameters.

In the embodiments of the present disclosure, for the deformation processing of at least part of the grid control planes, on the one hand, deformation of at least part of the body region is implemented, on the other hand, deformation of at least part of the background region corresponding to the grid control plane except the at least part of the body region is also implemented.

By using the technical solutions of the embodiments of the present disclosure, grid partition is performed based on the image to obtain a plurality of grid control planes, and deformation processing is performed on at least part of the body region of the target object based on the grid control plane to implement automatic adjustment of the body region of the target object, without manual operations of the users, which greatly improves the user's operation experience.

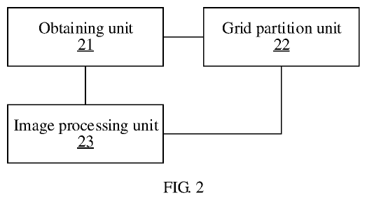

The embodiments of the present disclosure further provide an image processing apparatus. FIG. 2 is a schematic structural diagram of an image processing apparatus according to embodiments of the present disclosure. As shown in FIG. 2, the apparatus includes an obtaining unit 21, a grid partition unit 22, and an image processing unit 23.

The obtaining unit 21 is configured to obtain a first image.

The grid partition unit 22 is configured to perform grid partition on the first image obtained by the obtaining unit 21, to obtain a plurality of grid control planes.

The image processing unit 23 is configured to determine a target object in the first image obtained by the obtaining unit 21; and perform deformation processing on at least part of a body region of the target object corresponding to at least one of the plurality of grid control planes to generate a second image.

In the embodiments, the image processing unit 23 is configured to obtain body detection information of the target object in the first image. The body detection information includes body key point information and/or body contour point information. The body key point information includes coordinate information of a body key point. The body contour point information includes coordinate information of a body contour point.

In the embodiments, the image processing unit 23 is configured to determine at least part of the body region to be subjected to deformation processing in the target object to obtain first body detection information of the at least part of the body region; and determine a first group of grid control planes corresponding to the first body detection information, and perform deformation processing on the first group of grid control planes.

In the embodiments, the image processing unit 23 is configured to determine a corresponding first group of grid control planes based on first body key point information and/or first body contour point information included in the first body detection information, the first group of grid control planes including at least one grid control plane; and perform deformation processing on the at least one grid control plane to compress or stretch the at least part of the body region of the target object, and compress or stretch at least part of a background region other than the target object.

In one embodiment, the grid control plane is a first-type grid control plane.

The image processing unit 23 is configured to determine at least one first-type grid control plane corresponding to the first body detection information, and perform deformation processing on the at least one first-type grid control plane based on a first deformation parameter to compress or stretch a part of the body region of the target object corresponding to the at least one first-type grid control plane, and compress or stretch at least part of a background region other than the target object.

The first-type grid control plane includes a plurality of first-type grid control points.

The image processing unit 23 is configured to move at least part of the plurality of first-type grid control points included in the first-type grid control plane based on the first deformation parameter, to perform deformation processing on the first-type grid control plane; where deformation of the first-type grid control plane is implemented by means of the movement of any one of the plurality of first-type grid control points.

In another embodiment, the grid control plane is a second-type grid control plane.

The image processing unit 23 is configured to determine at least one second-type grid control plane corresponding to the first body detection information, and perform deformation processing on the at least one second-type grid control plane based on a second deformation parameter to compress or stretch a part of the body region of the target object corresponding to the at least one second-type grid control plane, and compress or stretch at least part of a background region other than the target object.

The second-type grid control plane includes a plurality of second-type grid control points.

The image processing unit 23 is configured to move at least part of the plurality of second-type grid control points included in the second-type grid control plane based on the second deformation parameter, to perform deformation processing on the second-type grid control plane; where deformation of a region in the second-type grid control plane, corresponding to any one of the plurality of grid control points, is implemented by means of the movement of the second-type grid control point.

In the embodiments of the present disclosure, in practical applications, the obtaining unit 21, the grid partition unit 22, and the image processing unit 23 in the apparatus are implemented by a Central Processing Unit (CPU), a Digital Signal Processor (DSP), a Microcontroller Unit (MCU), or a Field-Programmable Gate Array (FPGA) in the terminal.

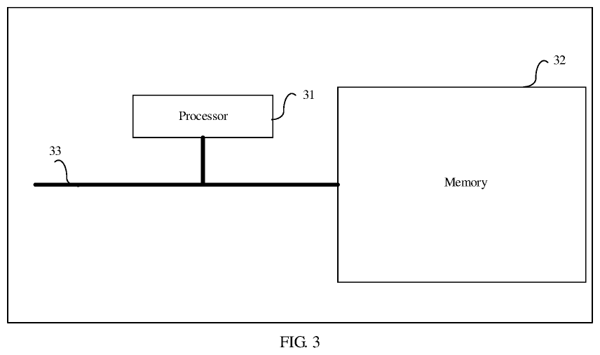

The embodiments of the present disclosure further provide an image processing apparatus. FIG. 3 is a schematic structural diagram of a hardware composition of the image processing apparatus according to the embodiments of the present disclosure. As shown in FIG. 3, the image processing apparatus includes a memory 32, a processor 31, and a computer program that is stored in the memory 32 and may run on the processor 31. The image processing method according to any one of the foregoing items in the embodiments of the present disclosure is implemented when the program is executed by the processor 31.

It may be understood that various components in the image processing apparatus are coupled together by means of a bus system 33. It may be understood that the bus system 33 is configured to implement connection communication between these components. In addition to a data bus, the bus system 33 further includes a power bus, a control bus, and a status signal bus. However, for the sake of clarity, various buses are annotated as the bus system 33 in FIG. 3.

It may be understood that the memory 32 may be a volatile memory or a non-volatile memory, or both. The non-volatile memory may be a Read-Only Memory (ROM), a Programmable Read-Only Memory (PROM), an Erasable Programmable Read-Only Memory (EPROM), an Electrically Erasable Programmable Read-Only Memory (EEPROM), a Ferromagnetic Random Access Memory (FRAM), a flash memory, a magnetic surface memory, an optical disc, or a Compact Disc Read-Only Memory (CD-ROM). The magnetic surface memory is a magnetic disc memory or a magnetic tape memory. The volatile memory is a Random Access Memory (RAM) that serves as an external cache. By way of example instead of limitation, many forms of RAMs are available, such as a Static Random Access Memory (SRAM), a Synchronous Static Random Access Memory (SSRAM), a Dynamic Random Access Memory (DRAM), a Synchronous Dynamic Random Access Memory (SDRAM), a Double Data Rate Synchronous Dynamic Random Access Memory (DDRSDRAM), an Enhanced Synchronous Dynamic Random Access Memory (ESDRAM), a Synclink Dynamic Random Access Memory (SLDRAM), and a Direct Rambus Random Access Memory (DRRAM). The memory 32 described in the embodiments of the present disclosure is intended to include but is not limited to these memories and any other suitable types of memories.

The method disclosed in the embodiments of the present disclosure above may be applied to the processor 31, or implemented by the processor 31. The processor 31 may be an integrated circuit chip, and has a signal processing capability. In an implementation process, operations in the method above are completed by using an integrated logic circuit of hardware in the processor 31 or an instruction in a form of software. The processor 31 is a general-purpose processor, a DSP, another programmable logic component, a discrete gate or a transistor logic component, a discrete hardware component, or the like. The processor 31 may implement or execute the methods, operations, and logical block diagrams disclosed in the embodiments of the present disclosure. The general-purpose processor is a microprocessor, any conventional processor, or the like. The operations of the method disclosed with reference to the embodiments of the present disclosure are directly implemented by a hardware decoding processor, or are implemented by using a combination of hardware and software modules in the decoding processor. The software module is located in a storage medium, and the storage medium is located in the memory 32. The processor 31 reads information in the memory 32 and completes the operations of the method above with reference to hardware thereof.

It should be noted that, when the image processing apparatus provided in the foregoing embodiments performs image processing, division of the program modules above is merely used as an example for description. In actual application, the processing above is allocated to different program modules according to requirements; that is, an internal structure of the apparatus is divided into different program modules, so as to complete all or some of the processing above. In addition, the image processing apparatus provided in the foregoing embodiments and the embodiments of the image processing method belong to a same concept. For a specific implementation process, reference is made to the method embodiments. Details are not described here again.

In exemplary embodiments, the embodiments of the present disclosure further provide a computer-readable storage medium, such as the memory 32 including the computer program. The computer program is executed by the processor 31 of the image processing apparatus, to complete the operations of the method above. The computer-readable storage medium is a memory such as FRAM, ROM, PROM, EPROM, EEPROM, Flash Memory, magnetic surface memory, optical disc, or CD-ROM, or a device including one or any combination of the foregoing memories, such as mobile phones, computers, tablet devices, personal digital assistants, etc.

The embodiments of the present disclosure further provide a computer-readable storage medium having a computer instruction stored thereon. The image processing method according to any one of the foregoing items in the embodiments of the present disclosure is implemented when the instruction is executed by the processor.

The embodiments of the present disclosure further provide a computer program, including a computer-readable instruction. When the computer-readable instruction is run in a device, a processor in the device executes executable instructions for implementing operations of the intelligent driving control method according to any one of the embodiments of the present disclosure.

In several embodiments provided in the present disclosure, it should be understood that the disclosed apparatus and method are implemented in another manner. The described device embodiments are merely exemplary. For example, the unit division is merely logical function division. In actual implementation, there may be another division manner. For example, multiple units or components are combined, integrated into another system, or some features are ignored, or not performed. In addition, the displayed or discussed components may be mutually coupled, or directly coupled, or communicatively connected by means of some interfaces, or indirectly coupled or communicatively connected by a device or unit, and may be electrically, mechanically, or in another form.

The foregoing units described as separate parts may or may not be physically separate, and parts displayed as units may or may not be physical units, may be located in one place, or may be distributed on multiple network units. Some or all of the units may be selected according to actual requirements to implement the objectives of the solutions in the embodiments.

In addition, functional units in the embodiments of the present disclosure may be integrated into one processing unit, or may be separately used as one unit, or two or more units may be integrated into one unit. The integrated unit can be implemented in the form of hardware or in the form of hardware plus software functional units.

A person of ordinary skill in the art may understand that all or some operations for implementing the foregoing method embodiments are achieved by a program by instructing relevant hardware. The foregoing program may be stored in a computer readable storage medium. When the program is executed, operations including the foregoing method embodiments are performed. Moreover, the foregoing storage medium includes any medium that may store program codes, such as a ROM, a RAM, a magnetic disc, or an optical disc.

Alternatively, when implemented in the form of a software functional module and sold or used as an independent product, the integrated unit of the present disclosure may also be stored in a computer-readable storage medium. Based on such an understanding, the technical solutions of the embodiments of the present disclosure essentially or the part contributing to the prior art may be implemented in a form of a software product. The computer software product is stored in one storage medium and includes several instructions for instructing a computer device (which may be a personal computer, a server, or a network device, etc.) to execute all or part of the methods described in the embodiments of the present disclosure. The foregoing storage medium includes any medium that may store program code, such as a mobile storage device, a ROM, a RAM, a magnetic disc, or an optical disc.

The above are only specific implementation modes of the present disclosure, but the scope of protection of the present disclosure is not limited thereto. Any person skilled in the art could easily conceive that changes or substitutions made within the technical scope disclosed in the present disclosure should be included in the scope of protection of the present disclosure. Therefore, the scope of protection of the present disclosure should be determined by the scope of protection of the appended claims.

1. An image processing method, comprising:
obtaining a first image, and performing grid partition on the first image to obtain a plurality of grid control planes;
determining a target object in the first image; and
performing deformation processing on at least part of a body region of the target object corresponding to at least one of the plurality of grid control planes to generate a second image.

2. The method according to claim 1, wherein determining the target object in the first image comprises:
obtaining body detection information of the target object in the first image, the body detection information comprising at least one of body key point information or body contour point information,
wherein the body key point information comprises coordinate information of a body key point; and
the body contour point information comprises coordinate information of a body contour point.

3. The method according to claim 1, wherein performing deformation processing on at least part of the body region of the target object corresponding to at least one of the plurality of grid control planes comprises:
determining at least part of the body region to be subjected to deformation processing in the target object to obtain first body detection information of the at least part of the body region; and
determining a first group of grid control planes corresponding to the first body detection information, and performing deformation processing on the first group of grid control planes.

4. The method according to claim 3, wherein determining the first group of grid control planes corresponding to the first body detection information, and performing deformation processing on the first group of grid control planes comprises:
determining a corresponding first group of grid control planes based on at least one of first body key point information or first body contour point information comprised in the first body detection information, the first group of grid control planes comprising at least one grid control plane; and
performing deformation processing on the at least one grid control plane to compress or stretch the at least part of the body region of the target object, and compress or stretch at least part of a background region other than the target object.

5. The method according to claim 3, wherein the grid control plane is a first-type grid control plane,
wherein determining the first group of grid control planes corresponding to the first body detection information, and performing deformation processing on the first group of grid control planes comprises:
determining at least one first-type grid control plane corresponding to the first body detection information, and performing deformation processing on the at least one first-type grid control plane based on a first deformation parameter to compress or stretch a part of the body region of the target object corresponding to the at least one first-type grid control plane, and compress or stretch at least part of a background region other than the target object.

6. The method according to claim 5, wherein the first-type grid control plane comprises a plurality of first-type grid control points,
wherein performing deformation processing on the at least one first-type grid control plane based on the first deformation parameter comprises:
moving at least part of the plurality of first-type grid control points comprised in the first-type grid control plane based on the first deformation parameter, to perform deformation processing on the first-type grid control plane,
wherein deformation of the first-type grid control plane is implemented by means of the movement of any one of the plurality of first-type grid control points.

7. The method according to claim 3, wherein the grid control plane is a second-type grid control plane,
wherein determining the first group of grid control planes corresponding to the first body detection information, and performing deformation processing on the first group of grid control planes comprises:
determining at least one second-type grid control plane corresponding to the first body detection information, and performing deformation processing on the at least one second-type grid control plane based on a second deformation parameter to compress or stretch a part of the body region of the target object corresponding to the at least one second-type grid control plane, and compress or stretch at least part of a background region other than the target object.

8. The method according to claim 7, wherein the second-type grid control plane comprises a plurality of second-type grid control points,
wherein performing deformation processing on the at least one second-type grid control plane based on the second deformation parameter comprises:
moving at least part of the plurality of second-type grid control points comprised in the second-type grid control plane based on the second deformation parameter, to perform deformation processing on the second-type grid control plane,
wherein deformation of a region in the second-type grid control plane, corresponding to any one of the plurality of second-type grid control points, is implemented by means of the movement of the second-type grid control point.

9. An image processing apparatus, comprising:
a memory storing processor-executable instructions; and
a processor arranged to execute the stored processor-executable instructions to perform operations of:
obtaining a first image, and performing grid partition on the first image to obtain a plurality of grid control planes;
determining a target object in the first image; and
performing deformation processing on at least part of a body region of the target object corresponding to at least one of the plurality of grid control planes to generate a second image.

10. The apparatus according to claim 9, wherein determining the target object in the first image comprises:
obtaining body detection information of the target object in the first image, the body detection information comprising at least one of body key point information or body contour point information,
wherein the body key point information comprises coordinate information of a body key point; and
the body contour point information comprises coordinate information of a body contour point.

11. The apparatus according to claim 9, wherein performing deformation processing on at least part of the body region of the target object corresponding to at least one of the plurality of grid control planes comprises:
determining at least part of the body region to be subjected to deformation processing in the target object to obtain first body detection information of the at least part of the body region; and
determining a first group of grid control planes corresponding to the first body detection information, and performing deformation processing on the first group of grid control planes.

12. The apparatus according to claim 11, wherein determining the first group of grid control planes corresponding to the first body detection information, and performing deformation processing on the first group of grid control planes comprises:
determining a corresponding first group of grid control planes based on at least one of first body key point information or first body contour point information comprised in the first body detection information, the first group of grid control planes comprising at least one grid control plane; and
performing deformation processing on the at least one grid control plane to compress or stretch the at least part of the body region of the target object, and compress or stretch at least part of a background region other than the target object.

13. The apparatus according to claim 11, wherein the grid control plane is a first-type grid control plane;
wherein determining the first group of grid control planes corresponding to the first body detection information, and performing deformation processing on the first group of grid control planes comprises:
determining at least one first-type grid control plane corresponding to the first body detection information, and performing deformation processing on the at least one first-type grid control plane based on a first deformation parameter to compress or stretch a part of the body region of the target object corresponding to the at least one first-type grid control plane, and compress or stretch at least part of a background region other than the target object.

14. The apparatus according to claim 13, wherein the first-type grid control plane comprises a plurality of first-type grid control points;
wherein performing deformation processing on the at least one first-type grid control plane based on the first deformation parameter comprises:
moving at least part of the plurality of first-type grid control points comprised in the first-type grid control plane based on the first deformation parameter, to perform deformation processing on the first-type grid control plane,
wherein deformation of the first-type grid control plane is implemented by means of the movement of any one of the plurality of first-type grid control points.

15. The apparatus according to claim 11, wherein the grid control plane is a second-type grid control plane;
wherein determining the first group of grid control planes corresponding to the first body detection information, and performing deformation processing on the first group of grid control planes comprises:
determining at least one second-type grid control plane corresponding to the first body detection information, and performing deformation processing on the at least one second-type grid control plane based on a second deformation parameter to compress or stretch a part of the body region of the target object corresponding to at least one first-type grid control plane, and compress or stretch at least part of a background region other than the target object.

16. The apparatus according to claim 15, wherein the second-type grid control plane comprises a plurality of second-type grid control points;
wherein performing deformation processing on the at least one second-type grid control plane based on the second deformation parameter comprises:
moving at least part of the plurality of second-type grid control points comprised in the second-type grid control plane based on the second deformation parameter, to perform deformation processing on the second-type grid control plane,
wherein deformation of a region in the second-type grid control plane, corresponding to any one of the plurality of second-type grid control points, is implemented by means of the movement of the second-type grid control point.

17. A non-transitory computer-readable storage medium having stored thereon computer-readable instructions that, when executed by a processor, cause the processor to perform an image processing method, the method comprising:
obtaining a first image, and performing grid partition on the first image to obtain a plurality of grid control planes;
determining a target object in the first image; and
performing deformation processing on at least part of a body region of the target object corresponding to at least one of the plurality of grid control planes to generate a second image.

18. The non-transitory computer-readable storage medium according to claim 17, wherein determining the target object in the first image comprises:
obtaining body detection information of the target object in the first image, the body detection information comprising at least one of body key point information or body contour point information,
wherein the body key point information comprises coordinate information of a body key point; and
the body contour point information comprises coordinate information of a body contour point.

19. The non-transitory computer-readable storage medium according to claim 17, wherein performing deformation processing on at least part of the body region of the target object corresponding to at least one of the plurality of grid control planes comprises:
determining at least part of the body region to be subjected to deformation processing in the target object to obtain first body detection information of the at least part of the body region; and
determining a first group of grid control planes corresponding to the first body detection information, and performing deformation processing on the first group of grid control planes.

20. The non-transitory computer-readable storage medium according to claim 19, wherein determining the first group of grid control planes corresponding to the first body detection information, and performing deformation processing on the first group of grid control planes comprises:
determining a corresponding first group of grid control planes based on at least one of first body key point information or first body contour point information comprised in the first body detection information, the first group of grid control planes comprising at least one grid control plane; and
performing deformation processing on the at least one grid control plane to compress or stretch the at least part of the body region of the target object, and compress or stretch at least part of a background region other than the target object.
